(19) United States
(12) Patent Application Publication
(10) Pub. No.: US 2016/0202882 A1
(43) Pub. Date: Jul. 14, 2016

(54) METHOD AND APPARATUS FOR ANIMATING DIGITAL PICTURES

(71) Applicant: Lumyer Inc., Los Angeles, CA (US)

(72) Inventors: Diego MORTILLARO, Milano (IT); Simone OFFREDO, Torino (IT); Francesco SCRUFARI, San Mauro Torinese (TO) (IT)

(21) Appl. No.: 14/995,931

(22) Filed: Jan. 14, 2016

Related U.S. Application Data
(60) Provisional application No. 62/103,406, filed on Jan. 14, 2015.

(51) Int. Cl. G06F 3/0484; G06T 13/80

(52) U.S. Cl. CPC G06F 3/04842; G06T 13/80; G06T 2200/24

(57) ABSTRACT

A method and apparatus may include generating a visual effect. The visual effect is generated from a video or an animation. The visual effect may include a representation of movement. The method may also include receiving a user selection from a user. The user selection may include a selection of the visual effect for application upon an image of the user. The method may also include applying the visual effect upon the image of the user to generate an enhanced image.

### BACKGROUND

1. Field

Certain embodiments of the present invention relate to animating digital pictures.

2. Description of the Related Art

Digital images have become effective in engaging people who have access to digital technologies and social media. Every day, people around the world capture and share digital images. By using the conventional methods and systems to capture and elaborate upon digital images, users may capture and share static pictures. Such static pictures can be shared among users. Digital images may be of a vector-type image or a raster-type image.

### SUMMARY

According to a first embodiment, a method may include generating a visual effect. The visual effect is generated from a video or an animation. The visual effect may include a representation of movement. The method may also include receiving a user selection from a user. The user selection may include a selection of the visual effect for application upon an image of the user. The method may also include applying the visual effect upon the image of the user to generate an enhanced image.

In the method of the first embodiment, the generating the visual effect may include pre-generating the visual effect before receiving the user selection. The generating the visual effect may include generating a plurality of frames from the video or the animation.

In the method of the first embodiment, the generating the visual effect further includes organizing the generated frames of each visual effect within different directories, wherein the generated frames of each visual element is saved within their own corresponding directory. The generating may also include organizing different opacities of each effect within different folders.

In the method of the first embodiment, the applying the visual effect upon the image may include customizing at least one of a rotation, a zoom, and an opacity of the visual effect.

In the method of the first embodiment, the method may also include sharing the enhanced image to a viewer. The method may also include determining whether the viewer is able to access a proprietary application corresponding to the enhanced image. If the user is able to access the proprietary application, the sharing may include displaying the enhanced image to the viewer via the proprietary application. If the user is not able to access the proprietary application, the sharing may include displaying the enhanced image in the form of a video or an image strip, wherein the image strip may include a plurality of frames.

In the method of the first embodiment, the image strip may include a single image file.

According to a second embodiment, an apparatus may include at least one processor. The apparatus may also include at least one memory including computer program code. The at least one memory and the computer program code may be configured, with the at least one processor, to cause the apparatus at least to generate a visual effect, wherein the visual effect is generated from a video or an animation, and the visual effect may include a representation of movement. The apparatus may also be caused to receive a user selection from a user. The user selection may include a selection of the visual effect for application upon an image of the user. The apparatus may also be caused to apply the visual effect upon the image of the user to generate an enhanced image.

In the apparatus of the second embodiment, the generating the visual effect may include pre-generating the visual effect before receiving the user selection, and generating the visual effect may include generating a plurality of frames from the video or the animation.

In the apparatus of the second embodiment, the generating the visual effect may also include organizing the generated frames of each visual effect within different directories. The generated frames of each visual element is saved within their own corresponding directory. The generating the visual effect may also include organizing different opacities of each effect within different folders.

In the apparatus of the second embodiment, the applying the visual effect upon the image may include customizing at least one of a rotation, a zoom, and an opacity of the visual effect.

In the apparatus of the second embodiment, the apparatus may be further caused to share the enhanced image to a viewer. The apparatus may also be caused to determine whether the viewer is able to access a proprietary application corresponding to the enhanced image. If the user is able to access the proprietary application, the sharing may include displaying the enhanced image to the viewer via the proprietary application. If the user is not able to access the proprietary application, the sharing may include displaying the enhanced image in the form of a video or an image strip, wherein the image strip may include a plurality of frames.

In the apparatus of the second embodiment, the image strip may include a single image file.

According to a third embodiment, a computer program product may be embodied on a non-transitory computer readable medium. The computer program product configured to control a processor to perform a method according to the first embodiment.

According to a fourth embodiment, a method may include selecting, by a user device, a visual effect for application upon an image of a user. The visual effect is generated from a video or an animation. The visual effect may include a representation of movement. The method may also include applying the visual effect upon the image to generate an enhanced image.

In the method of the fourth embodiment, the visual effect has been pre-generated before the selecting, and generating the visual effect may include generating a plurality of frames from the video or the animation.

In the method of the fourth embodiment, the applying the visual effect upon the image may include customizing at least one of a rotation, a zoom, and an opacity of the visual effect.

According to a fifth embodiment, an apparatus may include at least one processor. The apparatus may also include at least one memory including computer program code. The at least one memory and the computer program code may be configured, with the at least one processor, to cause the apparatus at least to select a visual effect for application upon an image of a user. The visual effect is generated from a video or an animation, and the visual effect may include a representation of movement. The apparatus may also be caused to apply the visual effect upon the image to generate an enhanced image.

In the apparatus of the fifth embodiment, the visual effect has been pre-generated before the selecting, and generating the visual effect may include generating a plurality of frames from the video or the animation.

In the apparatus of the fifth embodiment, the applying the visual effect upon the image may include customizing at least one of a rotation, a zoom, and an opacity of the visual effect.

According to a sixth embodiment, a computer program product may be embodied on a non-transitory computer readable medium. The computer program product configured to control a processor to perform a method according to the fourth embodiment.

### BRIEF DESCRIPTION OF THE DRAWINGS

For proper understanding of the invention, reference should be made to the accompanying drawings, wherein:

FIG. 1(a) illustrates an example method and system of certain embodiments of the invention.

FIG. 1(b) illustrates another example method and system of certain embodiments of the invention.

FIG. 2 illustrates an example method and system of another embodiment of the invention.

FIG. 3 illustrates a user interface for selecting a visual effect, where the interface may appear on a user device, in accordance with certain embodiments of the present invention.

FIG. 4 illustrates a user interface for downloading a new effect, in accordance with certain embodiments of the present invention.

FIG. 5(a) illustrates a user interface for downloading an effect to an end-user device, in accordance with certain embodiments of the present invention.

FIG. 5(b) illustrates another example method and system of certain embodiments of the invention.

FIG. 6 illustrates a user interface for customizing an effect's parameters by an end user, in accordance with certain embodiments of the present invention.

FIG. 7 illustrates how an animated image can be saved and made available to the end user, in accordance with certain embodiments of the present invention.

FIG. 8 illustrates how an animated image can be saved and shared outside a proprietary application, in accordance with certain embodiments of the present invention.

FIG. 9 illustrates a flowchart of a method in accordance with certain embodiments of the invention.

FIG. 10 illustrates a flowchart of a method in accordance with certain embodiments of the invention.

FIG. 11 illustrates an apparatus in accordance with certain embodiments of the invention.

FIG. 12 illustrates an apparatus in accordance with certain embodiments of the invention.

FIG. 13 illustrates an apparatus in accordance with certain embodiments of the invention.

### DETAILED DESCRIPTION

Certain embodiments of the present invention relate to animating digital pictures. Embodiments of the present invention may be directed to a method where a static digital image can be animated in one or more parts/areas by applying at least one animated visual effect.

While current approaches may create/generate a static digital image, the current technologies are generally not able to apply motion within the static digital image. Photo filters are one example of a technology that may be used to personalize a digital image. However, although the filters of the current approaches can emphasize colors and contrasts to static images, the current approaches generally do not provide any motion effect to the static images.

Although certain current approaches have tried to create a motion-like effect for a photo, these current approaches generally require users to take a video and to loop through the captured video.

In contrast to the other approaches, certain embodiments of the present invention are directed to a method and system for applying animated digital effects to digital images. One embodiment of the present invention is directed to a method for applying at least one digital effect onto a digital image. The at least one digital effect can be a visual effect that animates one or more parts/areas of the digital image. One embodiment of the present invention may be directed to a multimedia digital platform that allows the user to apply the at least one digital effect. The digital platform may be an user interface that is implemented by a processor in conjunction with a non-transitory computer readable medium of a user device or a server, for example. The digital platform may be a part of a proprietary application that adds the digital effects to the digital image. As such, the at least one digital effect may be a proprietary digital effect. Certain methods of the present invention may be implemented by fixed devices and/or mobile devices of the user. The devices may include or may be connected to a digital camera, and/or the devices can have online access or offline access to digital images.

The method and the system of certain embodiments of the present invention may be directed to providing a library of proprietary animated digital effects to the user. The user may then select one or more of the proprietary animated digital effects. The selected proprietary animated digital effect may then be applied to the digital images, in order to animate the digital images. The method and the system of certain embodiments may use a server-based multimedia interface/platform that generates and stores animated effects, that captures and modifies/elaborates upon the digital images, and/or that transforms and applies animated effects to create an effect of motion within the image.

In order to create an effect of motion within the image, certain embodiments may generate a visual effect by generating/creating a series of frames that are reproduced (for a viewer) in a particular sequence. The frames may be edited (prior to being reproduced in the particular sequence), and the frames may be stored on a server. The edited frames may be stored on the server in different directories, based on the type of the effect, as described in more detail below. The frames may then be reproduced on an proprietary application, where the proprietary application may assign a proprietary file extension to the visual effect, digital image, and/or the animated digital image. The proprietary extension may be created in order to optimize existing “rotation frame” mechanisms that may be available for mobile operating systems. The platform of certain embodiments may allow users to create, save, and share their own effects by using different commands.

The use of the proprietary extensions by certain embodiments may refer to the creation/generation of a file that contains all the frames in a sequence. The generated file may then be played using a proprietary player of the proprietary application. With certain embodiments, the generated file may be a single file as opposed to several generated frames/files. As such, certain embodiments may manage a single object (i.e., a single generated file) that can be rotated using less memory and bandwidth. This rotation may have a significant impact on the usability of the application and on the overall user experience. According to certain embodiments, the proprietary extension may be applied to an elaborated digital effect (which may be referred to as a “Lumy”). With certain embodiments, the proprietary extension may possibly refer to a digital effect that has been applied to an image, and not refer to the digital effect itself

In certain embodiments of the present invention, a user can select images (for which digital effects are to be applied) from the user's device, or the user may select images that are obtained from external sources. Certain embodiments may apply effects to images that have just been taken with a camera of the user device as well.

After selecting the image for which a visual/digital effect is to be applied upon, the user can then browse through a library of digital effects. The user may access the library via a user interface that is implemented on the user's device, and the user may select one or more effects to be applied to the selected image. Additional effects may be downloaded to the library of digital effects in order to expand the library of digital effects. The user may decide on how many and on which effects are to be downloaded on the device. Once an effect is downloaded to the library, the user may choose the effect from a dedicated area within the interface/platform.

Certain embodiments of the present invention may allow a user to customize parameters of the digital effects or of the image. By interacting with the user device, the user can customize several parameters of the image or of the digital effects. The user can customize the size, fade, orientation, dimensions, and/or color, for example, of the image or of the effects. The user can also customize animated images with filters, text, and/or music. The digital effects can be positioned with rotations, zooms, and movements based on, for example, drag and drop techniques and gestures. The playing/displaying of the digital effect may appear more or less fluid to the viewer, depending on the developed extension and the optimization of the basic structure that is provided by the operating system of the user device.

Certain embodiments may perform an analysis between a tradeoff between optimizing the effect's fluidity/quality and using the system resources of the user device. Providing a higher image/effect quality generally corresponds to using a higher processing capability that is required of the mobile handset to ensure a positive end-user interaction experience.

According to certain embodiments of the present invention, the images and the effects may be processed and saved on a server, on the user device, or on another platform using different digital formats. Users can save their animated images and also share their animated images on different social platforms via integrated Application Programming Interfaces (APIs) that have been made available to external providers.

The platform/interface of certain embodiments can be integrated with one or more social networks, where the integration may enable users to share their animated images outside the platform/interface. With certain embodiments, animated images may be embedded in a data circuit which allows users to have a consistent user experience, independent of the fruition channels that are used by the particular users. Embedded effects may be made available to the users via the user devices, and use of these effects may not require any download or uploading by the users.

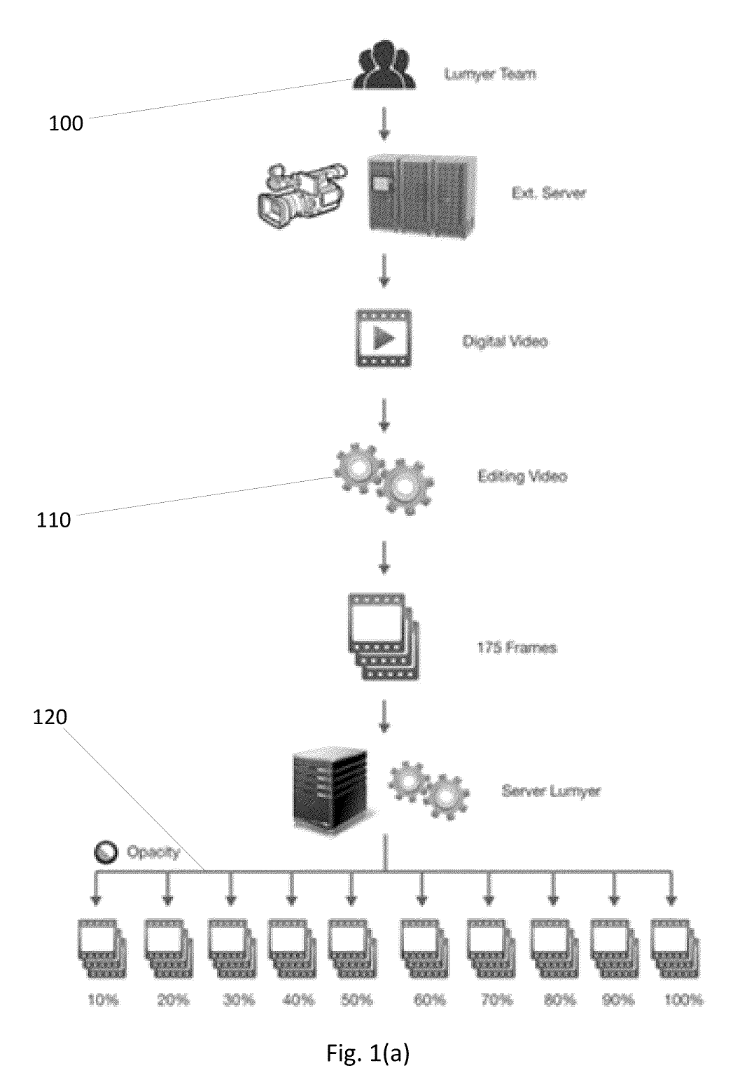

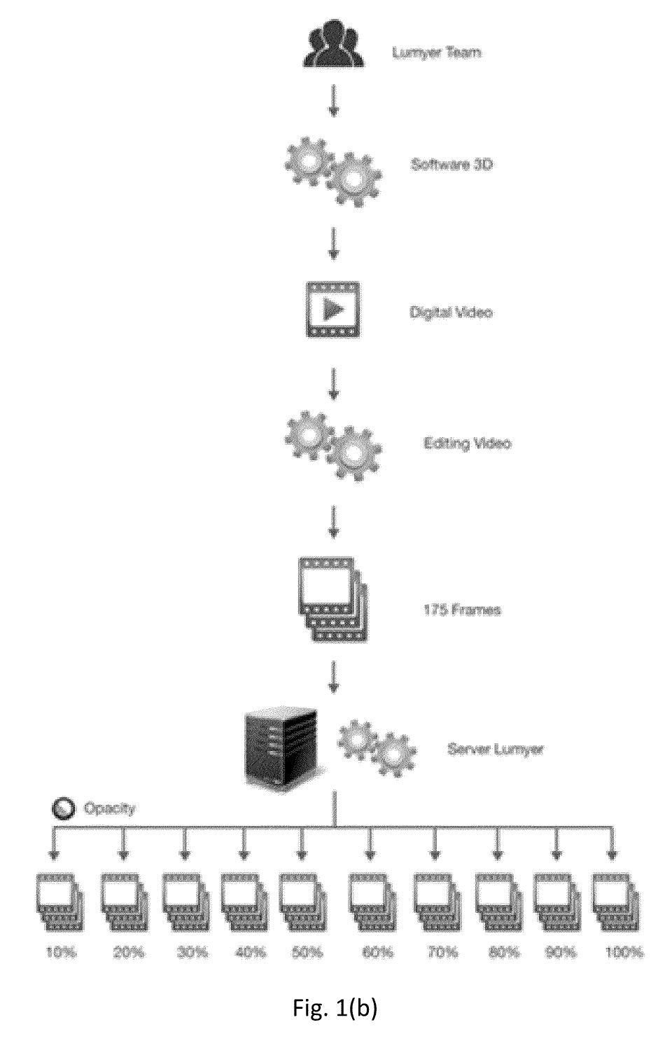

Referring to FIGS. 1(a) and 1(b), certain embodiments of the present invention may organize different effects within different directories. For example, the data for each effect may be stored within its own directory. Certain embodiments of the present invention may then organize different opacity levels within different folders. For example, each opacity level may have its own folder. As such, with certain embodiments of the present invention, each directory (corresponding to an effect) may contain a plurality of folders (with each folder corresponding to a different opacity of the effect).

FIG. 1(a) illustrates an example method and system of certain embodiments of the invention, showing how an effect is created and stored into a platform. Referring to FIG. 1(a), a development team 100 (such as a “Lumyer Team,” for example) can generate/create a visual effect (such as a “Lumyer effect”) by choosing a video from which the visual effect is to be created. The video can be chosen from different sources, such as from a camera recording, or from an online database, for example. The development team may then edit the video with a video editing software 110. A transparency may be applied to each relevant part of the effect. From the video, certain embodiments may obtain a plurality of image frames (such as 175 image frames, for example) that may then be provided/uploaded to a graphic processing server. The image frames may be in JPEG, PNG format, or any other type of digital format, for example. The uploading process may save the plurality of image frames in a dedicated directory (where each effect has its own directory). Certain embodiments may then generate as many folders 120 as needed, with the different folders corresponding to the different levels of opacity.

Referring to FIG. 1(b), a development team may also generate a 3-dimensional animation (such as a “Lumyer effect”) using third-party software. The 3-dimensional animation may be exported from a video format. The 3-dimensional animation may then be cut into loop of a certain duration (such as a 7 second length, for example). The 3-dimensional animation may then be applied as a loop of the certain duration upon an image. A plurality of frames (such as 175 frames, for example) may be extracted and individually saved as images. 175 images may be uploaded and saved to a dedicated directory on a server (such as a “Lumyer Server”). Each effect may have its own directory. Certain embodiments may generate as many folders as necessary for different levels of opacity.

With certain embodiments of the present invention, as described above, the number of directories may be based on the number of effects. The number of folders may change based on several factors such as, for example, the different levels of opacity that are pre-determined/pre-generated for each effect. Other embodiments may have different folders that correspond to different video quality levels, correspond to different sounds that may be applied, and/or correspond to different colors that may be applied, for example.

By pre-generating a folder for each opacity level (or for each video quality, or for each sound, and/or for each color, for example), certain embodiments of the present invention may improve system performance. By creating many folders, the system may pre-generate/pre-elaborate the different opacity levels of the different effects. In other words, each opacity level of each effect may be created/generated beforehand and stored within the folders. By using these pre-generated/pre-elaborated opacity levels, the user may reduce processing time when applying a desired opacity/effect.

According to certain embodiments of the present invention, a Lumyer effect can be created either by elaborating/modifying a video (as illustrated by FIG. 1(a)) or by creating digital images using 3D software (as illustrated by FIG. 1(b)), for example. The video to be modified may be internally produced or may be acquired from third parties. With certain embodiments the created visual effect may correspond to a movement effect. A movement effect (which may also be referred to as a “Lumyer effect”) may generally refer to a representation of movement extracted/extrapolated from a video or a series of images to create a desired effect. For example, Lumyer effects may correspond to representations of moving water for a “waterfall effect,” representations of moving debris for an “explosion effect,” and/or representations of moving air for a “fog effect,” for example.

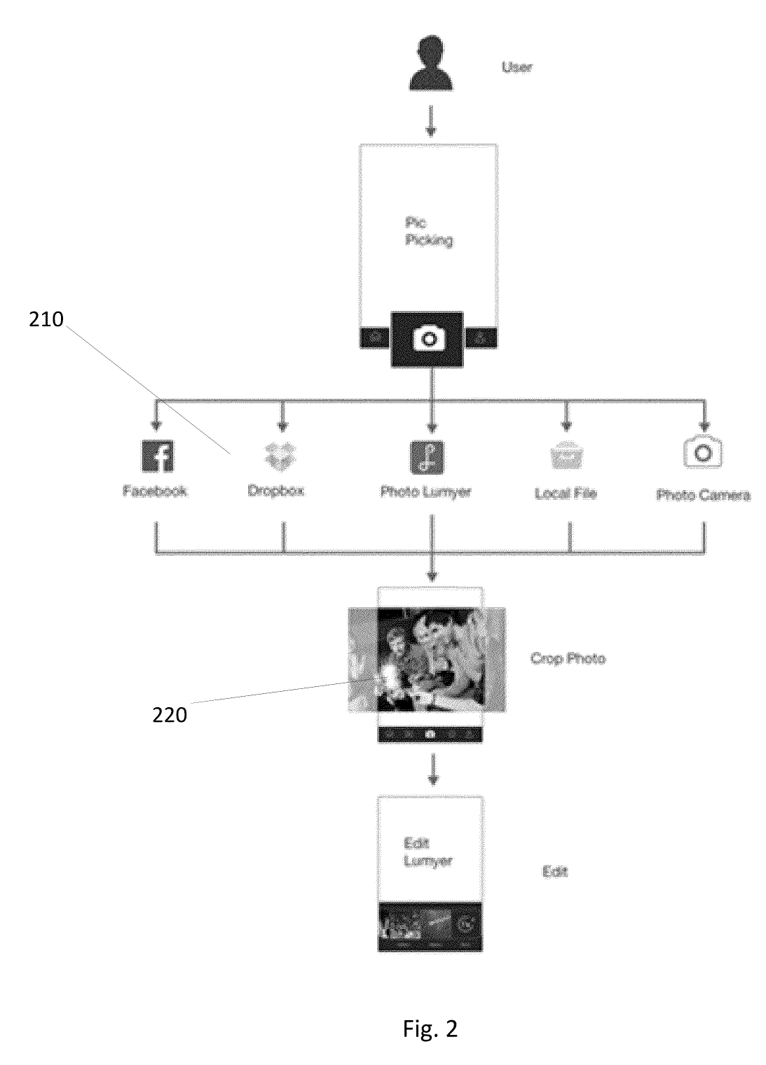

FIG. 2 illustrates an example method and system of another embodiment of the invention. Referring to FIG. 2, certain embodiments may apply proprietary filters to digital images. The different filters may modify the Red-Green-Blue (RGB) color channels, the contrast, the brightness, and/or the tones (the posterization) of the digital images.

Users can upload images (for which the digital effects are to be applied) from various sources 210. The sources may include, for example, a device camera, a device gallery, a Lumyer server storage, and/or an external Cloud storage service. The system of certain embodiments may first display the chosen image as a preview 220, and then the user may be able to edit the photo, and the user may be able to zoom and/or crop the chosen photo using the zoom and crop tools. The user may then edit the photo using Lumyer proprietary filters and effects in an “Edit” section.

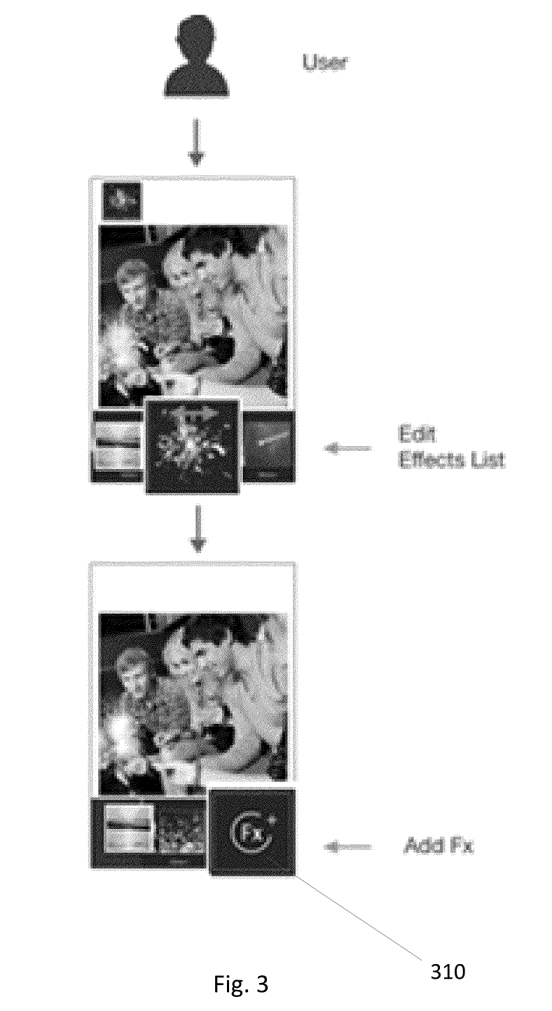

FIG. 3 illustrates a user interface for selecting a visual effect, where the interface may appear on a user device, in accordance with certain embodiments of the present invention. Referring to FIG. 3, users can access an edit section where the users can choose effects and filters through an interface of certain embodiments. With certain embodiments, users may activate an effect feature by pressing an “FX button.”A scrolling horizontal list may appear to display all the available selectable effects, either in alphabetical order or by order of typical use. Users may choose a preferred ordering method (for ordering the available effects) via a settings page of the application. Users may also be able to add other effects by pressing the “Add Fx” button 310 at the end of the list.

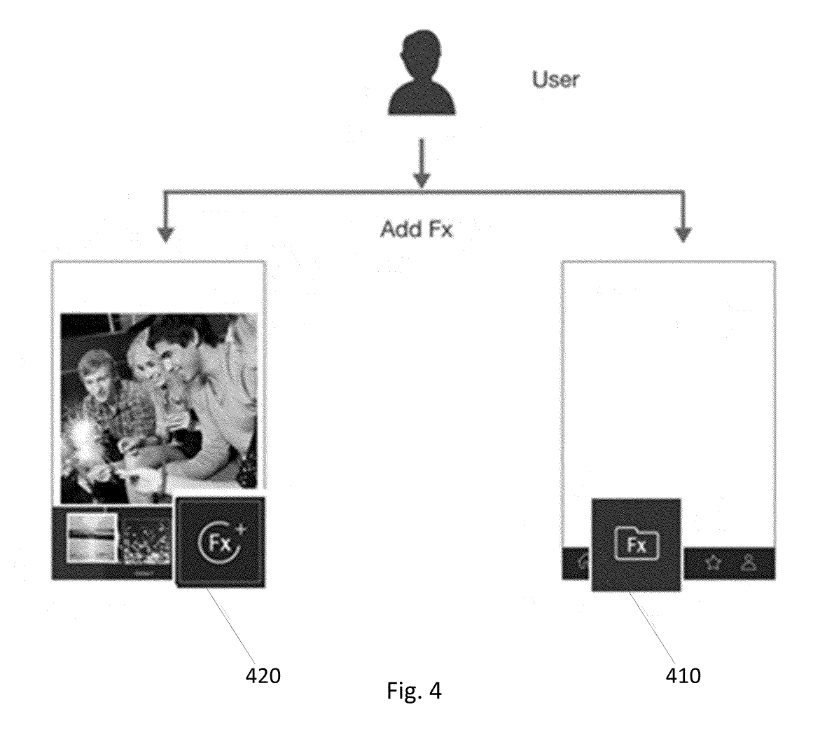

FIG. 4 illustrates a user interface for downloading a new effect in accordance with certain embodiments of the present invention. Referring to FIG. 4, users can download a new effect by either accessing an FX section 410 in the application or by interacting with a dedicated “Add Fx” button 420 in the “Edit” section.

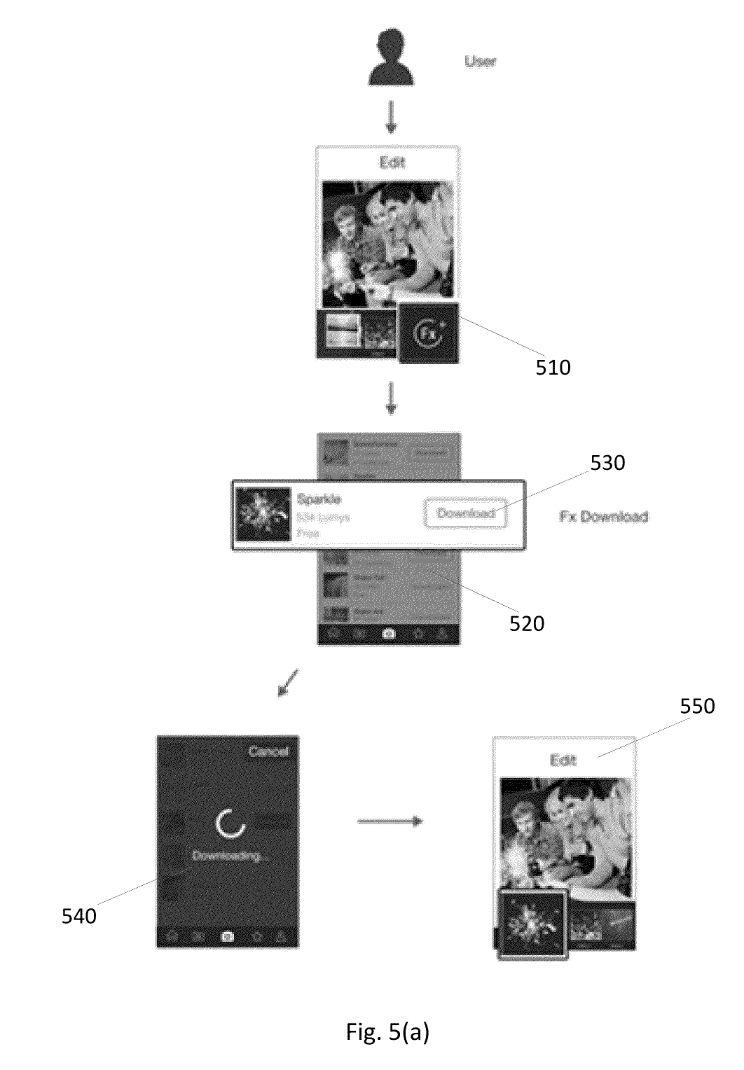

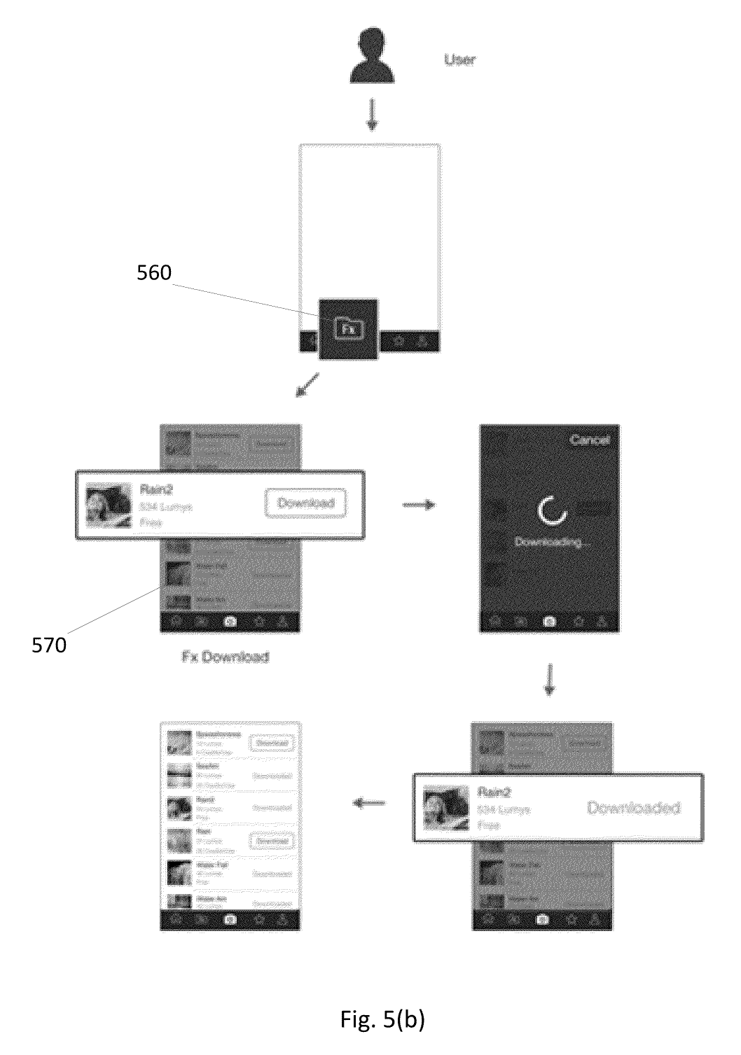

FIG. 5(a) illustrates a user interface for downloading an effect to an end-user device, in accordance with certain embodiments of the present invention. Referring to FIG. 5(a), when accessing the “Add Fx” section 510, users will be able to see a list 520 containing all the available effects. Each effect may have its own icon, name, and/or number of credits per use. With regard to credits, a user may have to gain/pay-for credits in order to download certain effects.

With certain embodiments, a “Download” button 530 may appear next to downloadable effects. A “Downloaded” button may appear for the already-downloaded effects. When a user clicks/accesses the “Download” button, a darker overlay 540 may cover the view, and a progression bar/indicator may appear to indicate the download progress in terms of a percentage or in terms of a visual effect. The visual effect may be in the form of a round shape or a linear shape, which indicates the download progress. Once each effect is downloaded, each downloaded effect will be available to be used in the above-described “Edit” section 550. Next, a “Downloaded” button will replace the “Download” button. At this point, users may be able to exit the “Edit” section or may be able to choose to download other effects.

FIG. 5(b) illustrates another example method and system of certain embodiments of the invention. Referring to FIG. 5(b), with certain embodiments, when accessing the “Fx section” 560, users may be able to see a list 570 that includes the available effects. Each effect may have its own icon, name, and/or number of credits per use.

When an effect has been downloaded, the “Edit” section may show up again and users may be able to keep editing their photo by adding the effect that was just downloaded. In the event that a user does not want to download any effect, the user may easily close the effect list and get back to the “Edit” section to keep modifying the photo with the already-downloaded effects.

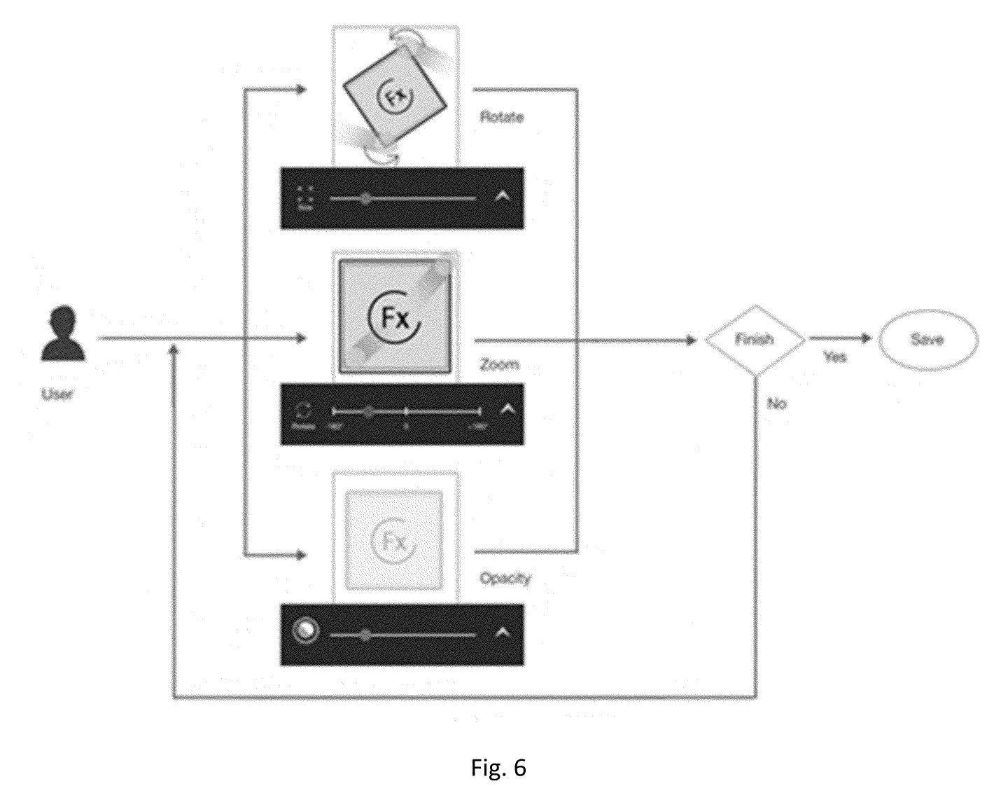

FIG. 6 illustrates a user interface for customizing an effect's parameters by an end user. Referring to FIG. 6, once an effect is selected, users may be able to move the effect across the view via a “drag-and-drop” gesture. The users may also rotate the effect with an intuitive two-fingers gesture or with an appropriate “ROTATE” command that may be utilized by tapping on a control icon (such as a small arrow, for example) that is placed on a bottom bar of the interface. Each effect can then be zoomed in or out via a pinch-to-zoom gesture or by accessing the appropriate “ZOOM” command by tapping on another control icon (such as another small arrow, for example) that is placed on the bottom bar. By accessing the same menu, users may be able to adjust effect's transparency by tapping on “OPACITY.” Additional parameters that may be modified also include a length, a width, and/or a 3D appearance of the effect.

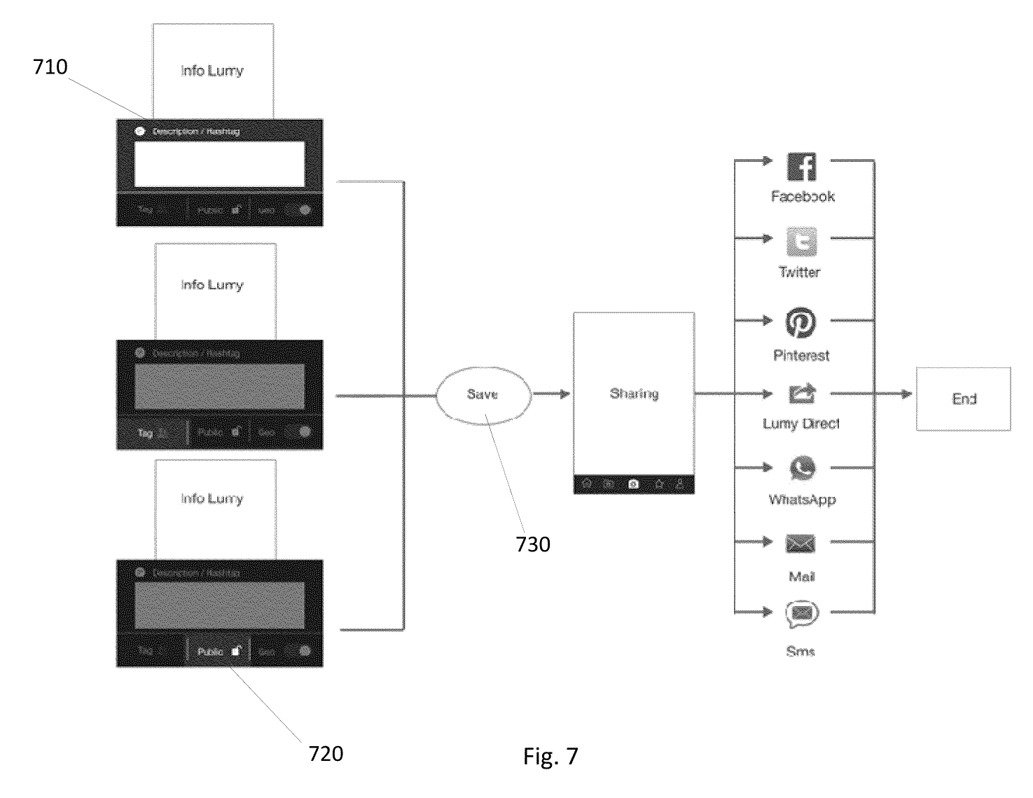

FIG. 7 illustrates how an animated image can be saved and made available to the end user. Referring to FIG. 7, besides adding (one or more) effects, a text, a drawing, and/or a colored filter, users may also add further information to their effects-enhanced photo, before publishing their enhanced photo on a platform (such as a Lumyer platform, for example). For example, a user may add a description by tapping on “DESCRIPTION/HASHTAG” 710. A user may edit visibility settings by tapping on a “Public/Private” setting 720. The default privacy setting may be “Public,” but this setting may be possibly changed via the application's user settings. Certain embodiments may allow users to add single or multiple tags that reference other users of the application. Referencing other users may include mentioning the names of the other users, by selecting their names from a list that will show up as an overlay on the animated image.

Next, by clicking on “Save” 730, the user may create an effect-enhanced image (a Lumy), after the image is processed on a Lumyer server. The effect-enhanced image may be presented on the owner's profile to be displayed right away. If the effect-enhanced image is set as public, the image will be potentially visible to every Lumyer user and will be published on a timeline feed of each of the user's followers. Each Lumy can be shared on a Lumyer platform, an external social media (such as Facebook, Twitter, etc.), a messaging system (such as SMS, Whatsapp, etc.), and/or an email message.

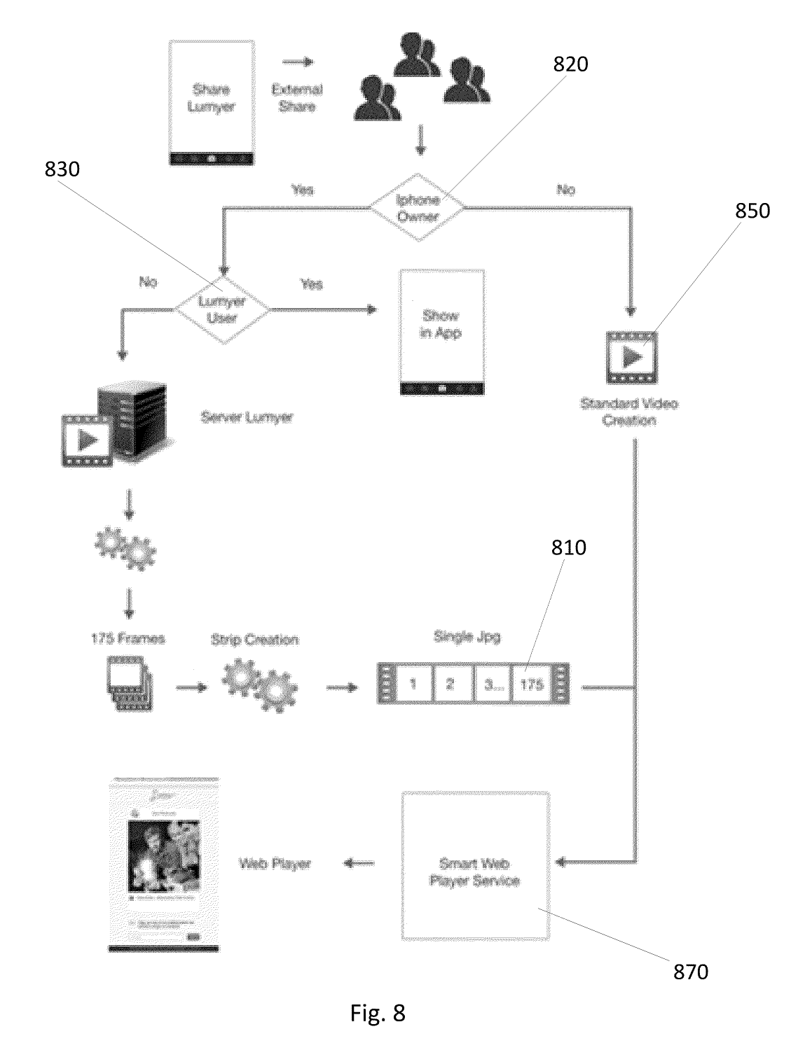

FIG. 8 illustrates how an animated image can be saved and shared outside a proprietary application, in accordance with certain embodiments of the present invention. Referring to FIG. 8, users of certain embodiments (such as “Lumyer users”) can share their enhanced images (Lumys) with other people who are not registered on the proprietary application (Lumyer) by tapping a sharing button that is available below every Lumy. As a result, a Hypertext Transfer Protocol (HTTP) link to the Lumy will be sent to the recipient(s). If the recipient(s) is not registered on Lumyer, the recipient may click or tap the HTTP link, and a Lumy will be displayed in a Web Player within a browser window (with all its related information) for the recipient. The Lumy itself may be sent as a standard video stream that loops inside the browser window. This method of viewing a Lumy may be used by users who access the content via a web browser on Android devices and/or on Apple iPad. Instead of viewing a Lumy within a browser window, iPhone users may instead see a looping strip of images 810 (of a same video height and length, with a similar effect as compared to a looping video). The looping strip of images 810 may be a single image file (i.e., a single jpeg file, for example).

When a user shares a Lumy with a receiver, the platform determines, at 820, if the receiver has a compatible phone (such as an iOS phone, for example) or not. If the receiver has an iOS phone (if the user is an iPhone Owner), the platform may check, at 830, if the proprietary (i.e., Lumyer) application has been downloaded on that phone. If the Lumyer application has been installed, the Lumy can be opened within the application. If the Lumyer application is not installed, the platform may elaborate/modify the Lumy by transforming the Lumy into a playable sequence of frames that are saved in a single file 810. The playable sequence of frames may then be displayed to represent the original Lumy. With one embodiment, the playable sequence of frames may be a sequence of a plurality of frames (such as, for example, 175 frames) that are saved in a single jpeg file. This file may be a static image of 175 frames. With certain embodiments of the present invention, an algorithm may play the sequence of frames as a video.

If the Lumy is shared with a receiver who does not have a compatible device (a non-iPhone owner such as an Android, a Windows, and/or an Os X, for example), the platform creates a standard video 850.

According to certain embodiments of the present invention, video and elaborated frames may be generated for each shared Lumy. According to certain embodiments, a “Smart Web Player Service” 870 may be used to deliver the appropriate format to the receiver. The Smart Web Player Service may be based on the characteristics of the receiver (such as, for example, whether the receiver is an iPhone owner or not).

According to certain embodiments of the present invention, in addition to using JPEGs, Portable Network Graphics (PNGs) may also be used to generate/present the animated images. Although JPEGs and PNGs are specifically mentioned, other embodiments may use any other type of format of digital images.

Embodiments of the present invention may use an image format that is supported by different browsers. Certain embodiments may allow a user to install a plug-in to visualize the PNG images. This format may support up to 32 bits and may handle different levels of opacities. This format may also be compressed without a loss of data, and this format may also be characterized by a high depth of color. The format used by certain embodiments may result in files of large dimensions.

Certain embodiments may use at least two types of PNG files: (1) PNG-8 and (2) PNG-24. The PNG-8 format may use 8-bit colors and may be used in a similar manner as GIF format files. Using the PNG-8 format may be useful for the compression of single color areas and may keep details sharp.

The PNG-24 format may use 24-bit colors and may have similarities with the JPEG format files. The PNG-24 format may support both photographic and geometrical images, and the PNG-24 format may support transparency on many levels.

According to certain embodiments of the present invention, a networking library may be used to generate/present the animated images. The networking library may be referred to as an “AFNetworking” library. AFNetworking may be a networking library for iOS and Mac OS X. AFNetworking may be built on top of the Foundation URL Loading System, extending the powerful high-level networking abstractions built into Cocoa. AFNetworking may have a modular architecture with well-designed, feature-rich APIs (application program interfaces).

According to certain embodiments of the present invention, a model-view-controller (MVC) may be used to generate/present the animated images. MVC may be a software pattern for implementing user interfaces. MVC may divide a given software application into three interconnected parts, so as to separate internal representations of information from the ways that information is presented to or accepted from the user. The central component, the model, may comprise application data, business rules, logic, and functions. A view can be any output representation of information, such as a chart or a diagram. Multiple views of the same information are possible, such as a bar chart for management and a tabular view for accountants. The third part, the controller, may accept input and convert the input to commands for the model or view.

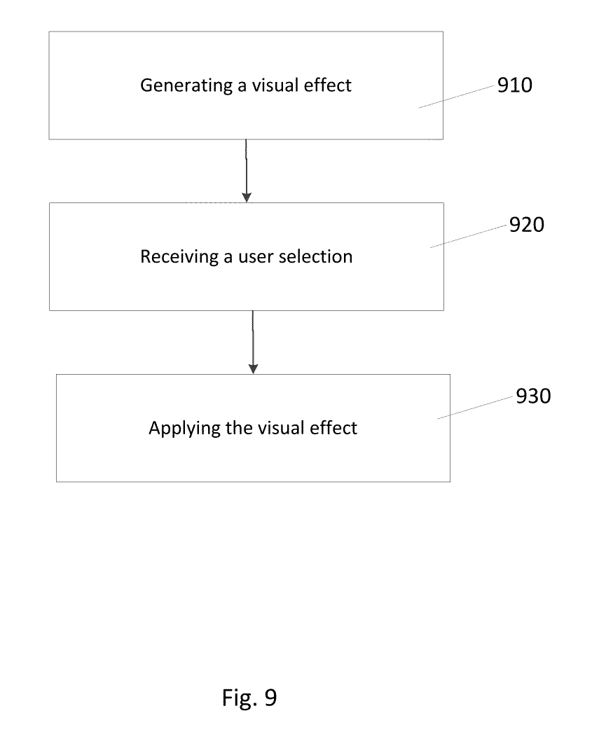

FIG. 9 illustrates a flowchart of a method in accordance with certain embodiments of the invention. The method illustrated in FIG. 9 includes, at 910, generating a visual effect. The visual effect is generated from a video or an animation. The visual effect may include a representation of movement. The method may also include, at 920, receiving a user selection from a user. The user selection may include a selection of the visual effect for application upon an image of the user. The method may also include, at 930, applying the visual effect upon the image of the user to generate an enhanced image.

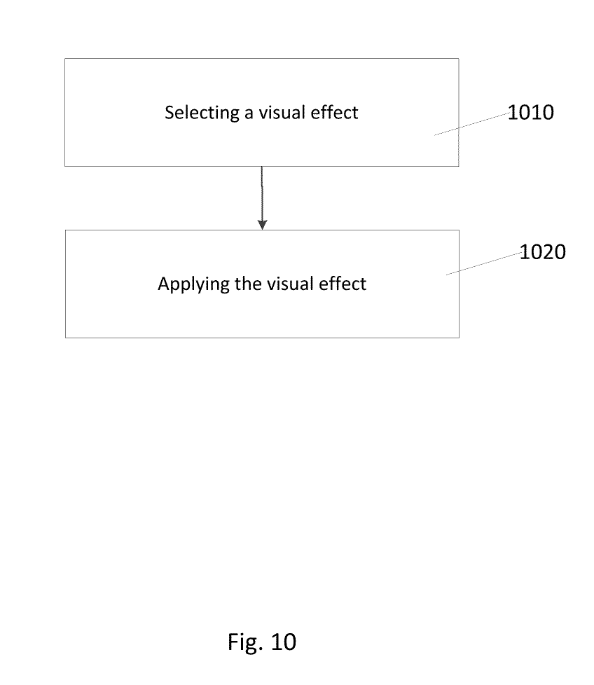

FIG. 10 illustrates a flowchart of a method in accordance with certain embodiments of the invention. The method illustrated in FIG. 10 includes, at 1010, selecting, by a user device, a visual effect for application upon an image of a user. The visual effect is generated from a video or an animation, and the visual effect may include a representation of movement. The method may also include, at 1020, applying the visual effect upon the image to generate an enhanced image.

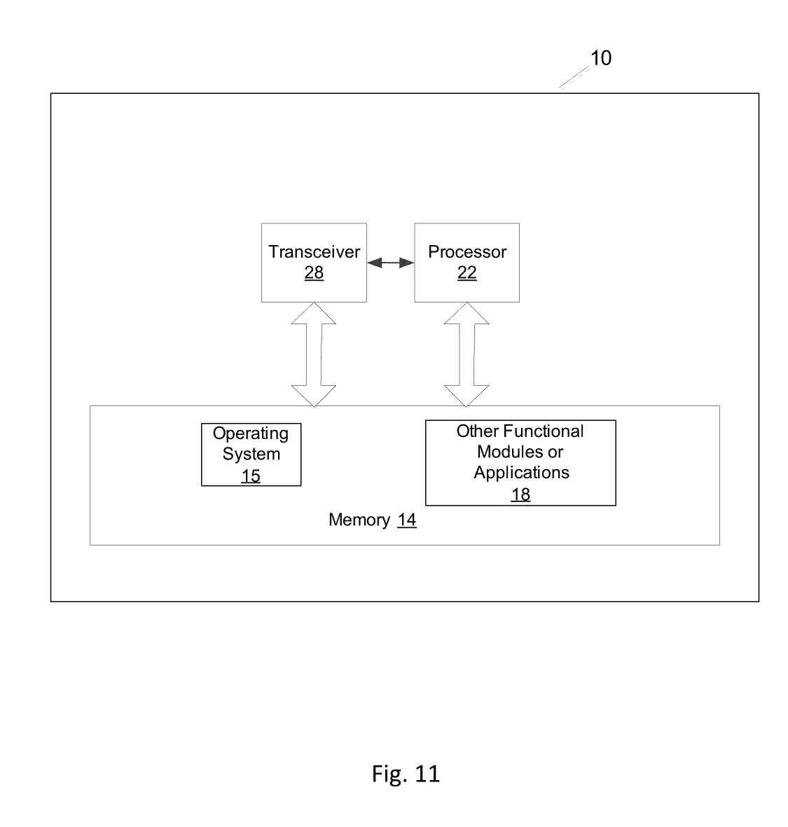

FIG. 11 illustrates an apparatus 10 according to another embodiment. In an embodiment, apparatus 10 may be an end user device. In another embodiment, apparatus 10 may be a server for generating effects and/or animated images. The apparatus may be configured to perform, at least, the methods described in FIG. 9 and/or FIG. 10. Apparatus 10 can include a processor 22 for processing information and executing instructions or operations. Processor 22 can be any type of general or specific purpose processor. While a single processor 22 is shown in FIG. 11, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

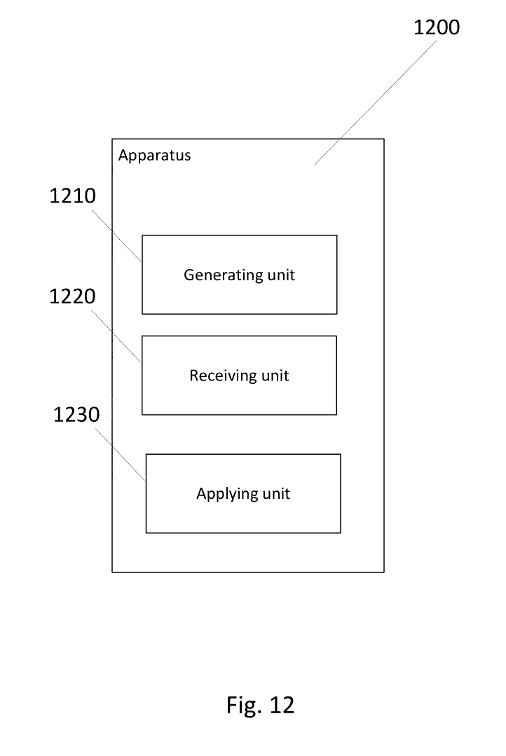

FIG. 12 illustrates an apparatus in accordance with certain embodiments of the invention. Apparatus 1200 can be an application server, for example. Apparatus 1200 can include a generating unit 1210 that generates a visual effect. The visual effect is generated from a video or an animation. The visual effect may include a representation of movement. Apparatus 1200 may also include a receiving unit 1220 that receives a user selection from a user. The user selection may include a selection of the visual effect for application upon an image of the user. Apparatus 1200 may also include an applying unit 1230 that applies the visual effect upon the image of the user to generate an enhanced image.

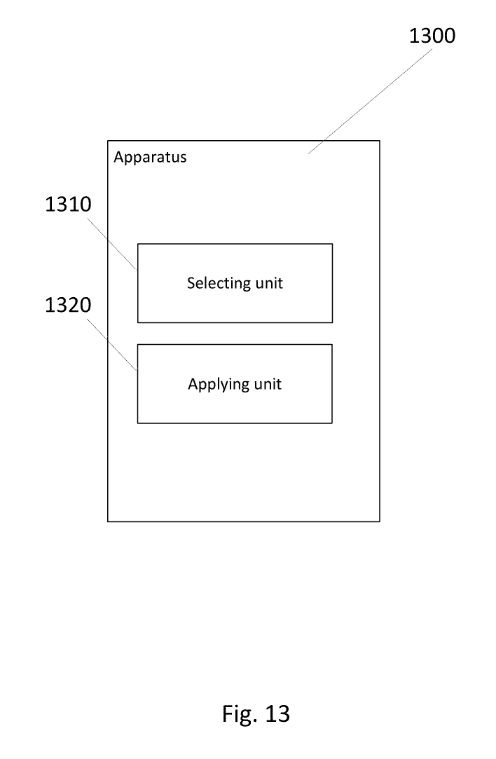

FIG. 13 illustrates an apparatus in accordance with certain embodiments of the invention. Apparatus 1300 can be a user device, for example. Apparatus 1300 can include a selecting unit 1310 that selects a visual effect for application upon an image of a user. The visual effect is generated from a video or an animation. The visual effect may include a representation of movement. Apparatus 1300 may also include an applying unit 1320 that applies the visual effect upon the image to generate an enhanced image.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
generating a visual effect, wherein the visual effect is generated from a video or an animation, and the visual effect comprises a representation of movement;
receiving a user selection from a user, wherein the user selection comprises a selection of the visual effect for application upon an image of the user; and
applying the visual effect upon the image of the user to generate an enhanced image.

2. The method according to claim 1, wherein the generating the visual effect comprises pre-generating the visual effect before receiving the user selection, and the generating the visual effect comprises generating a plurality of frames from the video or the animation.

3. The method according to claim 2, wherein the generating the visual effect further comprises:
organizing the generated frames of each visual effect within different directories, wherein the generated frames of each visual element is saved within their own corresponding directory; and
organizing different opacities of each effect within different folders.

4. The method according to claim 1, wherein the applying the visual effect upon the image comprises customizing at least one of a rotation, a zoom, and an opacity of the visual effect.

5. The method according to claim 1, further comprising:
sharing the enhanced image to a viewer;
and determining whether the viewer is able to access a proprietary application corresponding to the enhanced image, wherein
if the user is able to access the proprietary application, the sharing comprises displaying the enhanced image to the viewer via the proprietary application, and
if the user is not able to access the proprietary application, the sharing comprises displaying the enhanced image in the form of a video or an image strip, wherein the image strip comprises a plurality of frames.

6. The method according to claim 5, wherein the image strip comprises a single image file.

7. An apparatus, comprising:
at least one processor; and
at least one memory including computer program code,
the at least one memory and the computer program code configured, with the at least one processor, to cause the apparatus at least to
generate a visual effect, wherein the visual effect is generated from a video or an animation, and the visual effect comprises a representation of movement;
receive a user selection from a user, wherein the user selection comprises a selection of the visual effect for application upon an image of the user; and
apply the visual effect upon the image of the user to generate an enhanced image.

8. The apparatus according to claim 7, wherein the generating the visual effect comprises pre-generating the visual effect before receiving the user selection, and generating the visual effect comprises generating a plurality of frames from the video or the animation.

9. The apparatus according to claim 8, wherein the generating the visual effect further comprises:
organizing the generated frames of each visual effect within different directories, wherein the generated frames of each visual element is saved within their own corresponding directory; and
organizing different opacities of each effect within different folders.

10. The apparatus according to claim 7, wherein the applying the visual effect upon the image comprises customizing at least one of a rotation, a zoom, and an opacity of the visual effect.

11. The apparatus according to claim 7, wherein the apparatus is further caused to:
share the enhanced image to a viewer;
and determine whether the viewer is able to access a proprietary application corresponding to the enhanced image, wherein
if the user is able to access the proprietary application, the sharing comprises displaying the enhanced image to the viewer via the proprietary application, and
if the user is not able to access the proprietary application, the sharing comprises displaying the enhanced image in the form of a video or an image strip, wherein the image strip comprises a plurality of frames.

12. The apparatus according to claim 11, wherein the image strip comprises a single image file.

13. A computer program product, embodied on a non-transitory computer readable medium, the computer program product configured to control a processor to perform a method according to claim 1.

14. A method, comprising:
selecting, by a user device, a visual effect for application upon an image of a user, wherein the visual effect is generated from a video or an animation, and the visual effect comprises a representation of movement; and
applying the visual effect upon the image to generate an enhanced image.

15. The method according to claim 14, wherein the visual effect has been pre-generated before the selecting, and generating the visual effect comprises generating a plurality of frames from the video or the animation.

16. The method according to claim 14, wherein the applying the visual effect upon the image comprises customizing at least one of a rotation, a zoom, and an opacity of the visual effect.

17. An apparatus, comprising:
at least one processor; and
at least one memory including computer program code,
the at least one memory and the computer program code configured, with the at least one processor, to cause the apparatus at least to:
select a visual effect for application upon an image of a user, wherein the visual effect is generated from a video or an animation, and the visual effect comprises a representation of movement; and
apply the visual effect upon the image to generate an enhanced image.

18. The apparatus according to claim 17, wherein the visual effect has been pre-generated before the selecting, and generating the visual effect comprises generating a plurality of frames from the video or the animation.

19. The apparatus according to claim 17, wherein the applying the visual effect upon the image comprises customizing at least one of a rotation, a zoom, and an opacity of the visual effect.

20. A computer program product, embodied on a non-transitory computer readable medium, the computer program product configured to control a processor to perform a method according to claim 14.
